(19) United States
(12) Patent Application Publication
(10) Pub. No.: US 2022/0216508 A1
(43) Pub. Date: Jul. 7, 2022

(54) ELECTRODE FOR LITHIUM ION SECONDARY BATTERY

(71) Applicant: HONDA MOTOR CO., LTD., Tokyo (JP)

(72) Inventors: Toshimitsu TANAKA, Saitama (JP); Kiyoshi TANAAMI, Saitama (JP); Takuya TANIUCHI, Saitama (JP); Toshiyuki ARIGA, Saitama (JP)

(21) Appl. No.: 17/645,993

(22) Filed: Dec. 26, 2021

(30) Foreign Application Priority Data
Dec. 28, 2020 (JP) 2020-219556

(51) Int. Cl. H01M 10/0562; H01M 10/0525; H01M 4/80

(52) U.S. Cl. CPC H01M 10/0562; H01M 2004/021; H01M 4/80; H01M 10/0525

(57) ABSTRACT

To provide an electrode for a lithium ion secondary battery that can improve the diffusivity of lithium ions in an electrode material mixture when a metal porous body is used as a current collector, thereby improving the output characteristics and durability of the battery. A positive electrode 1 and a negative electrode 2, which are electrodes, respectively include a current collector 11 and a current collector 21 each including a metal porous body having communicating pores V, and an electrode material mixture 13 and an electrode material mixture 23, with which at least the pores V of the metal porous body are filled. At least an electrode active material and ionic conductor particles are dispersed in the electrode material mixtures 13 and 23. The ionic conductor particles are preferably oxide solid electrolyte particles.

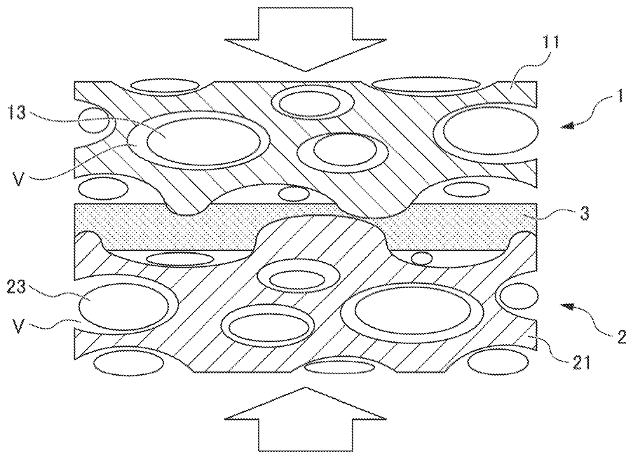

This application is based on and claims the benefit of priority from Japanese Patent Application No. 2020-219556, filed on 28 Dec. 2020, the content of which is incorporated herein by reference.

### BACKGROUND OF THE INVENTION

### Field of the Invention

The present invention relates to an electrode for a lithium ion secondary battery.

### Related Art

Conventionally, lithium ion secondary batteries have been widely used as secondary batteries having a high energy density. A liquid lithium ion secondary battery has a structure in which a separator is present between a positive electrode and a negative electrode and the battery cell is filled with a liquid electrolyte (electrolytic solution). In the case of an all-solid-state battery where the electrolyte is solid, a solid electrolyte is present between a positive electrode and a negative electrode.

As a method of increasing the filling density of an electrode active material, it has been proposed to use a metal porous body as current collectors constituting a positive electrode layer and a negative electrode layer (for example, see Patent Document 1). The metal porous body has a network structure with pores and a large surface area. By filling the interior of the network structure with an electrode material mixture including an electrode active material, the amount of the electrode active material per unit area of the electrode layer can be increased.

Patent Document 1: Japanese Unexamined Patent Application, Publication No. 2012-186139

### SUMMARY OF THE INVENTION

As described above, the amount of the electrode active material per unit area of the electrode layer can be increased by filling the interior of the network structure of the metal porous body with the electrode material mixture including the electrode active material, but the increase in the amount of the electrode active material leads to a decrease in ion diffusivity, which increases resistance and makes it difficult to charge and discharge at a high rate. Therefore, it is necessary to improve the ionic conductivity of the electrode material mixture.

In addition, the increase in resistance due to the increase in the amount of the electrode active material promotes lithium electrodeposition, which leads to a decrease in durability. From this point, of view, it is also necessary to improve the ionic conductivity of the electrode material mixture.

In response to the above issues, it is an object of the present invention to provide an electrode for a lithium ion secondary battery that can improve the ionic conductivity of an electrode material mixture when a metal porous body is used as a current collector, thereby improving the output characteristics and durability of the battery.

(1) A first aspect of the present invention relates to an electrode for a lithium ion secondary battery. The electrode includes a current collector including a metal porous body, and an electrode material mixture with which at least pores of the metal porous body are filled. At least an electrode active material and ionic conductor particles are dispersed in the electrode material mixture.

According to the invention of the first aspect, when the metal porous body is used as the current collector, the ionic conductivity of the electrode material mixture can be improved by dispersing the ionic conductor particles as the electrode material mixture.

(2) In a second aspect of the present invention according to the first aspect, the ionic conductor particles include oxide solid electrolyte particles.

(2) According to the invention of the second aspect, the oxide solid electrolyte particles can be dispersed as particles, and the ionic conductivity of the electrode material mixture can be particularly improved.

(3) In a third aspect of the present invention according to the first or second aspect, the ionic conductor particles are disposed on a surface of the electrode active material.

According to the invention of the third aspect, the ionic conductor particles are disposed on the surface of the electrode active material, thereby improving the ionic conductivity.

(4) In a fourth aspect of the present invention according to any one of the first to third aspects, the ionic conductor particles have a particle diameter of 10 nm or more and 2000 nm or less.

According to the invention of the fourth aspect, the ionic conductor particles ace finely dispersed and are easily disposed on the surface of the electrode active material, thereby improving the ionic conductivity of the electrode material mixture.

(5) In a fifth aspect of the present invention according to any one of the first to fourth aspects, the ionic conductor particles have a content of 0.1 parts by mass or more and 10 parts by mass or less with respect to 100 parts by mass of the electrode active material.

According to the invention of the fifth aspect, an appropriate amount of the ionic conductor particles can be easily disposed on the surface of the electrode active material, thereby improving the ionic conductivity of the electrode material mixture.

### BRIEF DESCRIPTION OF THE DRAWINGS

FIG. is a schematic diagram showing a cross section of a positive electrode, a negative electrode, and an electrolyte according to an embodiment of the present invention.

### DETAILED DESCRIPTION OF THE INVENTION

An embodiment of the present invention will now be described with reference to the drawing. The present invention is not limited to the following embodiment.

In the following embodiment, a lithium ion battery including a liquid as an electrolyte is described as an example, but the present invention is not limited thereto. The electrode for a lithium ion secondary battery of the present invention can also be applied to a so-called all-solid-state battery including a solid as an electrolyte.

The electrode for a lithium ion secondary battery of the present invention may be applied to a positive electrode, a negative electrode, or both in a lithium ion secondary battery.

### <Overall Structure of Lithium Ion Secondary Battery>

As shown in FIG. in the lithium ion secondary battery of this embodiment, a positive electrode 1 and a negative electrode 2, which are the electrodes for a lithium ion secondary battery of the present invention, are arranged in a stack with an electrolyte 3 provided therebetween. As the materials of the positive electrode and the negative electrode which constitute the lithium ion secondary battery, two types of materials are selected from materials capable of constituting electrodes. The charge-discharge electric potentials of the two types of compounds are compared, the material exhibiting a higher electric potential is used in the positive electrode, the material exhibiting a lower electric potential is used in the negative electrode, and thereby any battery can be constructed. The lithium ion secondary battery is constructed by stacking any number of cells each including a positive electrode 1, an electrolyte 3, and a negative electrode 2.

The positive electrode 1 and the negative electrode 2 respectively include a current collector 11 and a current collector 21 each including a metal porous body having pores that are continuous with each other (communicating pores), which are equivalent to the “pores” of the present invention. The electrodes each further include a current collector tab (not shown) connected to an end portion of the corresponding current collector. The pores of the current collectors 11 and 21 are respectively filled with an electrode material mixture (positive electrode material mixture) 13 and an electrode material mixture (negative electrode material mixture) 23, which each contain an electrode active material and ionic conductor particles.

In the end portion of the current collector, a region that is not filled with the electrode material mixture (not shown) is provided. After filling a filled region with the electrode material mixture in the current collector, rolling is performed for the purpose of improving the filling density of the electrode active material and thinning the layer. At this time, a portion of the end portion of the current collector is easily extended and extends out from the end portion of the current collector to form a current collecting tab forming portion. The current collecting tab forming portion is electrically connected to a lead tab (not shown) by welding or the like.

### (Electrolyte)

With respect to the electrolyte 3, the battery to which the electrode for a lithium ion secondary battery of this embodiment can be applied may be provided with a liquid electrolytic solution in which an electrolyte is dissolved in a non-aqueous solvent, or with a solid electrolyte, which is a solid or gel electrolyte.

The solid electrolyte is not limited, and is, for example, a sulfide solid electrolyte material, an oxide solid electrolyte material, a nitride solid electrolyte material, or a halide solid electrolyte material. Examples of the sulfide solid electrolyte material include LPS halogens (Cl, Br, and I) and Li₂S—P₂S₅, and Li₂S—P₂S₅—LiI for lithium ion batteries. The above-described “Li₂S—P₂S₅” refers to a sulfide solid electrolyte material including a raw material composition containing Li₂S and P₂S₅, and the same applies to the “Li₂S—P₂S₅—LiI”. Examples of the oxide solid electrolyte material include NASICON-type oxides, garnet-type oxides, and perovskite-type oxides for lithium ion batteries. Examples of the NASICON-type oxides include oxides containing Li, Al, Ti, P, and O (e.g., Li_{1.5}Al_{0.5}T_{1.5}(PO₄)₃). Examples of the garnet-type oxides include oxides containing Li, La, Zr, and O (e.g., Li₂La₃Zr₂O₁₂). Examples of the perovskite-type oxides include oxides containing Li, La, Ti, and O (e.g., LiLaTiO₃).

The electrolyte dissolved in the non-aqueous solvent is not limited, and is, for example, LiPF₆, LiBF₄, LiClO₄, LiN (SO₂CF₃) LiN (SO₂C₂F₅)₂, LiCF₃SO₃, LiC₄F₃SO₃, LiC (SO₂CF₃)₃, LiF, LiCl, Li I, Li₂S, Li₃N, Li₃P, Li₁₀GeP₂S₁₂ (LGPS), Li₃PS₄, Li₆PS₅Cl, Li₇P₂S₃I, LiₓPO_{y}N₂ (x=2y+3z−5, LiPON), Li₂La₃Zr₂O₁₂ (LLZO), Li₃ₓLa_{2/3-x}TiO, (LLTO), Li₁₊ₓAlₓTi₂₋ₓ (PO₄)₃ (0≤x≤1, LATP), Li_{1.5}Al_{0.5}Ge_{1.5}(PO₄)₃ (LAGP), Li_{1+x+y}Al_{z}Ti_{2-z}SiyP_{3-y}O₁₂, Li_{1+x+y}Alₓ(Ti, Ge)₂₋ₓSiyP_{3-y}O₁₂ , and Li₄₋₂ₓZnₓGeO₄ (LISICON). One of the above may be used alone, or two or more of the above may be used in combination.

The non-aqueous solvent included in the electrolytic solution is not limited, and examples thereof include aprotic solvents such as carbonates, esters, ethers, nitriles, sulfones, and lactones. Specifically, ethylene carbonate (EC), propylene carbonate (PC), diethyl carbonate (DEC), dimethyl carbonate (DMC), ethyl methyl carbonate (EMC), 1,2-dimethoxyethane (DME), 1,2-diethozyethane (DEE), tetrahydrofuran (THF), 2-nethyltetrahydrofuran, dloxane, 1,3-dioxolane, diethylene glycol dimethyl ether, ethylene glycol dimethyl ether, acetonitrile (AN), propionitrile, nitromethane, N,N-dimethylfortnamlde (DMF), dimethyl sulfoxide, sulfolane, γ-butyrolactone, and the like may be used. One of the above may be used alone, or two or more of the above may be used in combination.

### (Separator)

The lithium ion secondary battery of this embodiment may include a separator, especially when a liquid electrolyte is used. The separator is located between the positive electrode and the negative electrode. The material and thickness of the separator are not limited, and any known separator that can be used for lithium ion secondary batteries, such as polyethylene or polypropylene, can be applied.

### <Electrode for Lithium Ion Secondary Battery>

The following describes the current collector, and the electrode material mixture including an active material and ionic conductor particles, which constitute the electrode for a lithium ion secondary battery of the present invention.

### (Current Collector)

The current collectors 11 (positive electrode current collector 11) and 21 (negative electrode current collector 21) constituting the electrodes for a lithium ion secondary battery of this embodiment each include a metal porous body having pores V that are continuous with each other, as shown schematically in FIG. Since the current collectors 11 and 21 have pores V that are continuous with each other, the pores V of the current collectors 11 and 21 can be respectively filled with the electrode material mixtures 13 and 23 each containing an electrode active material. Thus, the amount of the electrode active material per unit area of the electrode layer can be increased. The form of the metal porous body is not limited as long as i. has pores that are continuous with each other. Examples of the form of the metal porous body include a foam metal having pores by foaming, a metal mesh, an expanded metal, a punching metal, and a metal nonwoven fabric. The metal used in the metal porous body is not limited as long as it has electric conductivity. Examples thereof include nickel, aluminum, stainless steel, titanium, copper, and silver. Among these, as the current collector constituting the positive electrode, a foamed aluminum, foamed nickel, and foamed stainless steel are preferable. As the current collector constituting the negative electrode, a foamed copper and foamed stainless steel are preferable.

The current collectors 11 and 21, which are metal porous bodies, each have pores V that are continuous with each other within the current collector, and have a larger surface area than a conventional current collector that is a metal foil. As shown in FIG. by using the above-described metal porous bodies as the current collectors 11 and 21, the above-described pores V can be filled with the electrode material mixtures 13 and 23 each containing the electrode active material. This enables the amount of the active material per unit area of the electrode layer to be increased, and thus the volumetric energy density of the lithium ion secondary battery can be improved. In addition, since the electrode material mixtures 13 and 23 are easily fixed, it is not necessary to thicken a coating slurry for forming the electrode material mixture layer when the electrode material mixture layer is thickened, unlike a conventional electrode including a metal foil as a current collector. Accordingly, it is possible to reduce a binder such as an organic polymer compound that has been necessary for thickening. Therefore, the capacity per unit area of the electrode can be increased, and a higher capacity of the lithium ion secondary battery can be achieved.

### (Electrode Material Mixture)

The electrode material mixtures 13 and 23 are respectively disposed in the pores V formed within the current collectors. The electrode material mixtures 13 and 23 respectively include at least a positive electrode active material and ionic conductor particles and a negative electrode active material and ionic conductor particles.

### (Electrode Active Material)

The positive electrode active material is not limited as long as it can occlude and release lithium ions. Examples thereof include LiCoO₂, Li (Ni_{5/10}Co_{2/10}Mn_{3/10})O₂, Li (Ni_{6/10}Co_{2/10}Mn_{2/10}) O₂, Li (Ni_{8/10}Co_{1/10}Mn_{1/10}) O₂, Li (Ni_{0.8}Co_{0.15}Al_{0.05}) O₂, Li (Ni_{1/6}Co_{4/5}Mn_{1/6}) 0₂, Li (Ni_{1/3}Co_{1/3}Mn_{1/3}) O₂, Li (Ni_{1/2}Co_{1/3}Mn_{1/3}) O₂, LiCoO₄, LiMn₂O₄, LiNiO₂, LiFePO₄,lithium sulfide, and sulfur.

The negative electrode active material is not limited as long as it can occlude and release lithium ions. Examples thereof include metallic lithium, lithium alloys, metal oxides, metal sulfides, metal nitrides, Si, SiO, and carbon materials such as artificial graphite, natural graphite, hard carbon, and soft carbon.

### (Ionic Conductor Particles)

The present invention is characterized in that the electrode material mixture contains ionic conductor particles together with the electrode active material described above. The ionic conductor particles improve the ionic conductivity of the electrode material mixture, which improves the output characteristics and durability of the battery.

As the ionic conductor particles, particles of the above-described substances that can be used as the solid electrolyte can be used. From the viewpoint of processability, it is preferable to use oxide solid electrolyte particles.

The oxide solid electrolyte is not limited, but a lithium-based oxide is preferable. Examples thereof include Li₇La₃Zr₂O₁₂ (LLZO), Li_{6.75}La₃Zr_{1.75}Ta_{0.25}O₁₂ (LLZTO), Li_{0.33}La_{0.56}TiO₃ (LLTO), Li_{1.3}Al_{0.3}Ti_{1.7}(PO₄)₃ (LATP), and Li_{1.6}Al_{.06}Ge_{1.4}(PO₄)₃ (LAGP).

In addition, Li oxide salts, such as LiF, LiAlO₂, Li₂ZrO₃, Li₃VO₄, Li₂Si₂O₂, Li₂WO₄, LiNbO₃, Li₂MoO₄, [Li, La]TiO₃, Li₂TiO₃, LiPON, and Li₂O₂B₃ can be used.

It is preferable that the ionic conductor particles have a lithium ionic conductivity of 1.0×10⁻³S/cm or more in a bulk state.

Although the particle size of the ionic conductor particles is not limited, it is preferable that the particle size is 0.02 μm or more and 10 μm or less that is smaller than the particle size of the electrode active material. If the particle size is too small, the particles tend to aggregate and ionic conductivity is inhibited, resulting in high cell resistance. On the other hand, if the particle size is too large, the volume of the battery increases, which hinders the reduction of the energy density. The particle size is a D50 median diameter measured by a laser diffraction/scattering method.

The content of the ionic conductor particles is preferably 0.1 parts by mass or more and 10 parts by mass or less with respect to 100 parts by mass of the electrode active material. If the content of the ionic conductor particles is less than 0.1 parts by mass, the required ionic conductivity cannot be obtained. If the content of the ionic conductor particles is more than 10 parts by mass, a significant, decrease in battery capacity is caused. They are not desirable.

The ionic conductor particles are dispersed in the electrode material mixture, and preferably the ionic conductor particles are disposed on the surface of a particle of the electrode active material. In addition, it is also preferable that the ionic conductor particles are present on the surface of an aggregate of a plurality of particles of the electrode active material. Both aspects ere within the scope of the present invention. The above aspects can be achieved by the manufacturing method described below.

### (Other Components)

The electrode material mixture may optionally include components other than an electrode active material and ionic conductor particles. The other components are not limited, and can be any components that can be used in fabricating a lithium ion secondary battery. Examples thereof include a conductivity aid and a binder. The conductivity aid of the positive electrode is, for example, acetylene black, and the binder of the positive electrode is, for example, polyvinylidene fluoride. Examples of the binder of the negative electrode include sodium carboxyl methyl cellulose, styrene-butadiene rubber, and sodium polyacrylate.

### <Method for Manufacturing Electrode for Lithium Ion Secondary Battery>

The electrode for a lithium ion secondary battery according to this embodiment is obtained by filling pores that are continuous with each other of a metal porous body as a current collector with an electrode material mixture including an electrode active material and ionic conductor particles.

### (Electrode Material Mixture Composition Formation Step)

First, an electrode active material, ionic conductor particles, and, if necessary, a binder and a conductivity aid, are uniformly mixed by a conventionally known method, and thus an electrode material mixture composition adjusted to a predetermined viscosity, preferably in the form of a paste, is obtained.

### (Electrode Active Material Filling Step)

Subsequently, pores of a metal porous body, which is a current collector, are filled with the above electrode material mixture composition as an electrode material mixture. The method of filling the current collector with the electrode material mixture is not limited, and is, for example, a method of filling the pores of the current collector with a slurry containing the electrode material mixture by applying pressure using a plunger-type die coater.

The method for manufacturing the electrode for a lithium ion secondary battery according to the present embodiment may include steps other than those described above. For example, the manufacturing method may include a step of forming a current collector tab by compressing an end portion of the metal porous body as the current collector. In addition to the above, known methods that are used in manufacturing an electrode for a lithium ion secondary battery can be applied. For example, the current collector filled with the electrode material mixture is dried, then pressed, and thus the electrode for a lithium ion secondary battery is obtained. The density of the electrode material mixture can be improved by pressing and can be adjusted to a desired density.

Although a preferred embodiment of the present invention has been described above, the present invention is not limited to the above embodiment and can be modified as appropriate.

### EXAMPLES

The present invention will be described in more detail based on examples, but the present invention is not limited thereto.

### Example 1

### [Formation of Positive Electrode Material Mixture]

A positive electrode material mixture slurry was obtained by dispersing 94 parts by mass of LiNi_{1/8}Co_{1/10}Mn_{1/10}O₂ as a positive electrode active material, 3.5 parts by mass of denka black as a conductivity aid, 2 parts by mass of polyvinylidene fluoride as a binder, and 0.5 parts by mass of LiNbO₃ as ionic conductor particles in NMP in a stepwise manner using a homogenizer. The LiNbO₃ used has a median diameter (D50) of 0.05 μm and a bulk lithium ionic conductivity of 0.8×10⁻⁷ S/cm.

### [Formation of Positive Electrode]

The following metal porous body was used as a current collector, and the obtained positive electrode material mixture slurry was supplied to the surface of the porous body. Pores of the porous body were filled with the positive electrode material mixture by pressing the porous body with a roller under a load of 5 kg/cm². Subsequently, the porous body filled with the positive electrode material mixture was dried at 100° C. for 40 minutes to remove an organic solvent. Thus, a positive electrode was obtained. The basis weight of the positive electrode material mixture in the final battery state (after pressing) was 90 g/cm². Material: Aluminum
Porosity: 95%
Number of pores: 46 to 50 pores/inch
Average pore diameter: 0.5 mm
Specific surface area: 5000 m²/m³
Thickness: 1.0 mm

### (Formation of Negative Electrode Material Mixture)

A negative electrode material mixture slurry was obtained by dispersing 96.5 parts by mass of natural graphite as a negative electrode active material, 1 part by mass of denka black as a conductivity aid, and 1.5 parts by mass of styrene-butadiene rubber and 1 part by mass of carboxymethyl cellulose as binders in water in a stepwise manner using a homogenizer.

### (Formation of Negative Electrode)

A negative electrode included a metal porous body similar to that of the positive electrode current collector and was formed in the same manner as with the positive electrode, except that the material was copper.

### Example 2

In Example 2, a positive electrode and a negative electrode were obtained in the same manner as in Example 1, except that the composition of the positive electrode material mixture was set to 94 parts by mass of positive electrode active material, 3 parts by mass of conductivity aid, 2 parts by mass of binder, and 1 part by mass of ionic conductor particles.

### Example 3

In Example 3, a positive electrode and a negative electrode were obtained in the same manner as in Example 2, except that Li_{1.3}Al_{0.3}Tl_{1.7}(PO₄)₃ (LATP) was used instead of LiNbO₃ as ionic conductor particles.

### Comparative Example 1

In Comparative Example 1, a positive electrode and a negative electrode were obtained in the same manner as in Example 1, except that the composition of the positive electrode material mixture was set to 94 parts by mass of positive electrode active material, 4 parts by mass of conductivity aid, and 2 parts by mass of binder, and ionic conductor particles were not used.

### <Fabrication of Lithium Ion Secondary Battery>

As a separator, a non-woven fabric (thickness: 20 μm), which is a three-layered polypropylene/polyethylene/polypropylene laminate, was prepared. A stack of the positive electrode, the separator, and the negative electrode prepared above was inserted into a pouch-like container prepared by heat-sealing an aluminum laminate for secondary batteries (manufactured by Dai Nippon Printing Co., Ltd.). As an electrolytic solution, a solution in which LiPF₆ was dissolved at a concentration of 1.2 mol/L in a solvent in which ethylene carbonate, diethyl carbonate, and ethyl methyl carbonate were mixed at a volume ratio of 30:40:30 was used. Thus, lithium ion secondary batteries of Examples 1 to 3 and Comparative Example 1 were fabricated.

### <Test Examples>

The following evaluations were performed on the lithium ion secondary batteries obtained in the examples and comparative example. The results are shown in Table 1.

(Capacity Retention Rate 2 C/0.33 C) The fabricated lithium ion secondary batteries were left to stand at a measurement temperature of 25° C. for 1 hour, then were subjected to constant current charge at 0.2 C to 4.2 V, and subsequently to constant voltage charge at a voltage of 4.2 V for 1 hour, then were left to stand for 1 hour. Thereafter, the batteries were subjected to discharge at a discharge rate of 2 C to 2.5 V to determine the capacity at 2 C discharge. In the same way, the capacity at 0.33 C discharge was determined, and the ratio oi the two was set as the capacity retention rate 2 C/0.33 C.
(Capacity Retention Rate after 1000 Cycles)

The lithium ion secondary batteries fabricated were left to stand at a measurement temperature of 25° C. for 1 hour, then were subjected to constant current charge at 0.2 C to 4.2 V and subsequently to constant voltage charge at a voltage of 4.2 V for 1 hour, then were left to stand for 1 hour. Thereafter, the batteries were subjected to discharge at a discharge rate of 0.2 C to 2.5 V. Then, the initial discharge capacity was measured.

As a charge-discharge cycle durability test, one cycle was defined as an operation of constant current charge at a charge rate of 0.5 C to 4.2 V, and subsequent constant current discharge at a discharge rate of 1 C to 2.5 V in a thermostated bath at 45° C. This operation was repeated 1000 cycles. After the completion of the 1000 cycles, the thermostated bath was set to 25° C., and the lithium ion secondary batteries were left to stand for 24 hours in the state after 2.5 V discharge. Subsequently, the discharge capacity after the durability test was measured in the same manner as in the measurement of the initial discharge capacity. The rate of the discharge capacity after the durability test with respect to the initial discharge capacity was calculated as the capacity retention rate.

(Resistance Increase Rate after 1000 Cycles)

The fabricated lithium ion secondary batteries were left to stand at a measurement temperature of 25° C. for 1 hour and adjusted to a state of charge (SOC) of 50%. Then, the lithium ion secondary batteries were subjected to pulse discharge at a C rate of 0.2 C for 10 seconds, and the voltage at the time of the completion of the 10 second discharge was measured. The voltage at the time of the completion of the 10 second discharge was plotted with respect to the current at 0.2 C, with the horizontal axis being the current value, and the vertical axis being the voltage. Subsequently, after being left to stand for 5 minutes, the lithium ion secondary batteries were subjected to auxiliary charge to reset the SOC to 50%, and further left to stand for 5 minutes. The above operation was performed at C rates of 0.5 C, 1.0 C, 1.5 C, 2.0 C, 2.5 C, and 3.0 C, and the voltage at the time of the completion of the 10 second discharge was plotted with respect to the current at each C rate. The slope of the approximate straight line obtained from each plot was defined as the initial cell resistance.

For the cells after the above 1000 cycle durability test, the cell resistance after the durability test was determined in the same manner as the measurement of the initial cell resistance. The cell resistance after the durability test with respect to the initial cell resistance was calculated as the resistance Increase rate.

TABLE 1

| | | | | Comparative |
|---|---|---|---|---|
| | Example 1 | Example 2 | Example 3 | Example 1 |
| Positive Electrode Active | 94/3.5/2/0.5 | 94/3/2/1 | 94/3/2/1 | 94/4/2/— |
| Material/Conductivity | LiNbO₃ | LiNbO₃ | LATP | — |
| Capacity Retention Rate (2 C/0.33 C) | 31.20% | 33.60% | 26.90% | 21.80% |
| Capacity Retention Rate (1000 cycle) | 82% | 84% | 85% | 79% |
| Resistance increase Rate (1000 cycle) | 156% | 149% | 142% | 190% |

From the results in Table 1, it can be understood that the lithium ion batteries including the positive electrodes of the present invention are superior to the comparative example in terms of the capacity retention rate 2 C/0.33 C, the capacity retention rate after 1000 cycles, and the resistance increase rate after 1000 cycles.

### EXPLANATION OF REFERENCE NUMERALS

1 positive electrode

11 current collector (positive electrode current collector)

13 electrode material mixture (positive electrode material mixture)

2 negative electrode

21 current collector (negative electrode current collector)

23 electrode material mixture (negative electrode material mixture)

3 electrolyte

V pore

What is claimed is:

1. An electrode for a lithium ion secondary battery, the electrode comprising:
a current collector comprising a metal porous body; and
an electrode material mixture with which at least pores of the metal porous body are filled,
the electrode material mixture comprising at least an electrode active material and ionic conductor particles, the electrode active material and the ionic conductor particles being dispersed in the electrode material mixture.

2. The electrode for a lithium ion secondary battery according to claim 1, wherein the ionic conductor particles comprise oxide solid electrolyte particles.

3. The electrode for a lithium ion secondary battery according to claim 1, wherein the ionic conductor particles are disposed on a surface of the electrode active material.

4. The electrode for a lithium ion secondary battery according to claim 1, wherein the ionic conductor particles have a particle diameter of 10 nm or more and 2000 nm or less.

5. The electrode for a lithium ion secondary battery according to claim 1, wherein the ionic conductor particles have a content of 0.1 parts by mass or more and 10 parts by mass or less with respect to 100 parts by mass of the electrode active material.
